(19) United States
(12) Patent Application Publication
(10) Pub. No.: US 2022/0131586 A1
(43) Pub. Date: Apr. 28, 2022

(54) METHOD OF CHANNEL STATE INFORMATION (CSI) FEEDBACK, METHOD OF IDENTIFYING SPACE DOMAIN (SD) AND FREQUENCY DOMAIN (FD) BASIS SUBSETS, AND USER EQUIPMENT

(71) Applicants: NTT DOCOMO, INC., Tokyo (JP); DOCOMO INNOVATIONS,INC., PaloAlto, CA (US)

(72) Inventors: Nadisanka Rupasinghe, Tokyo (JP); Satoshi Nagata, Chiyoda-ku, Tokyo (JP); Yuki Matsumura, Tokyo (JP)

(73) Assignee: NTT DOCOMO, INC., Tokyo (JP)

(21) Appl. No.: 17/436,871

(22) PCT Filed: Mar. 9, 2020
(86) PCT No.: PCT/US2020/021733

§ 371 Date: Sep. 7, 2021

Related U.S. Application Data
(60) Provisional application No. 62/815,212, filed on Mar. 7, 2019.

(51) Int. Cl. H04B 7/06; H04W 72/04

(52) U.S. Cl. CPC H04B 7/0626; H04B 7/0634; H04B 7/0617; H04W 72/0453; H04B 7/0658; H04W 72/042; H04W 72/046; H04B 7/063

(57) ABSTRACT

A method of Channel State Information (CSI) feedback in a wireless communication system includes: obtaining, with a user equipment, a first value that is a beam number value; obtaining, with the user equipment, a second value that is a scaling factor value for a vector pattern of a size M; and assigning, with the user equipment, the first value and the second value across a plurality of layers. The plurality of layers are layers with a rank indicator (RI) of a value being greater than 2. The method further includes assigning, with the user equipment, the first value and the second value to layers in a given rank out of the plurality of layers. The first value and the second value are common for the layers in the given rank.

### CROSS-REFERENCE TO RELATED APPLICATIONS

This application claims priority to U.S. Provisional Patent Application Ser. No. 62/815,212, titled “METHOD OF DETERMINING BASIS SUBSETS IN SPATIAL DOMAIN AND FREQUENCY DOMAIN,” which was filed on Mar. 7, 2019, and is incorporated herein by reference in its entirety.

### TECHNICAL FIELD

One or more embodiments disclosed herein relate to a method of method of Channel State Information (CSI) feedback, method of identifying Space Domain (SD) and Frequency Domain (FD) basis subsets, and user equipment.

### BACKGROUND

5G New Radio (NR) supports Type II channel state information (CSI) feedback for rank 1 and rank 2. In the Type II CSI feedback, an amplitude scaling mode is configured.

In the amplitude scaling mode, a user equipment (UE) may be configured to report a wideband (WB) amplitude with a subband (SB) amplitudes and SB phase information. In the conventional scheme, considerable fraction of the total overhead may be occupied by overhead for the SB amplitude and phase reporting. The SB precoder generation in NR Rel.15 Type II CSI for single layer transmission.

W=W_{space}W_{coeff} (1)

The matrix W (Nₜ×N_{SB}) captures precoding vectors for N_{SB} sub-bands. Nₜ denotes the number of available TXRU ports. W_{space} (Nₜ×2L) consists of the 2L wideband spatial 2D-Discrete Fourier Transform (DFT) beams. The matrix capturing the SB combination coefficients is represented in (1) by W_{coeff}. The amplitude and phase information for the SB to be reported may be in W_{coeff}. Reporting the amplitude and phase information occupies large portion of a feedback overhead. Therefore, it is necessary to the amplitude and phase information to be reported.

The compression of the amplitude and phase information may be performed by time domain compression. The time domain compression can be incorporated here. Let U={set of selected 2D−DFT spatial beams}. Now, the u^{th} row w_{coeff}^{u} of W_{coeff} which captures the complex combination coefficient associated with u^{th}(∈U) spatial beam can be given as,

W_{coeff}^{u}=[c₁^{u}c₂^{u}. . . c_{N}_{_{SB}}^{u}] (2)

where cᵢ^{u}, i∈{1, . . . , N_{SB}} is the combination coefficient for i^{th} sub-band of u^{th} spatial beam. Note here that, (2) captures frequency domain channel representation of the u^{th} spatial beam. Since the beam focuses the energy to a particular direction, intuitively it can be understood that there will be few scatterers within the channel. As a result, if we consider the time domain representation of the channel corresponding to u^{th} spatial beam, there will be few significant taps in the channel impulse response. If these significant taps can be identified properly and fed back to the gNB, frequency domain channel can be almost accurately regenerated at the gNB. This way the time domain compression can reduce feedback overhead associated with W_{coeff} by reporting the information of significant channel taps. Number of significant taps to report may differ based on the approach considered for detecting significant taps in the channel impulse response.

### CITATION LIST

### Non-Patent Reference

[Non-Patent Reference 1] 3GPP TS 38.214 (V15.3.0), “NR; Physical layer procedures for data”, October, 2018
[Non-Patent Reference 2] 3GPP RAN #82, RP-182863, “Revised WID: Enhancements on MIMO for NR”, December, 2018
[Non-Patent Reference 3] 3GPP RAN1 #95, “RAN1 Chairman's Notes “, November, 2018
[Non-Patent Reference 4] 3GPP RAN #96, R1-1902811, “Type II CSI feedback enhancement”, February, 2019
[Non-Patent Reference 5] 3GPP RAN1 Meeting #96,” RAN1 Chairman's Notes”, February, 2019
[Non-Patent Reference 6] 3GPP RAN1 #96b,” RAN1 Chairman's Notes”, April, 2019

### SUMMARY

One or more embodiments provide a method of Channel State Information (CSI) feedback in a wireless communication system that includes: obtaining, with a user equipment, a first value that is a beam number value; obtaining, with the user equipment, a second value that is a scaling factor value for a vector pattern of a size M; and assigning, with the user equipment, the first value and the second value across a plurality of layers. The plurality of layers are layers with a rank indicator (RI) of a value being greater than 2.

Other aspects of the disclosure will be apparent from the following description and the appended claims.

### BRIEF DESCRIPTION OF THE DRAWINGS

FIG. 1 is a diagram showing a configuration of a wireless communication system according to one or more embodiments.

FIG. 2 is a diagram showing a layer configuration according to one or more embodiments of the present invention.

FIG. 3 shows an example in accordance with one or more embodiments.

FIG. 4 shows a flowchart showing an operation in a wireless communication system according to one or more embodiments of the present invention.

FIG. 5 shows a block diagram of an assembly in accordance with one or more embodiments.

FIG. 6 shows a block diagram of an assembly in accordance with one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

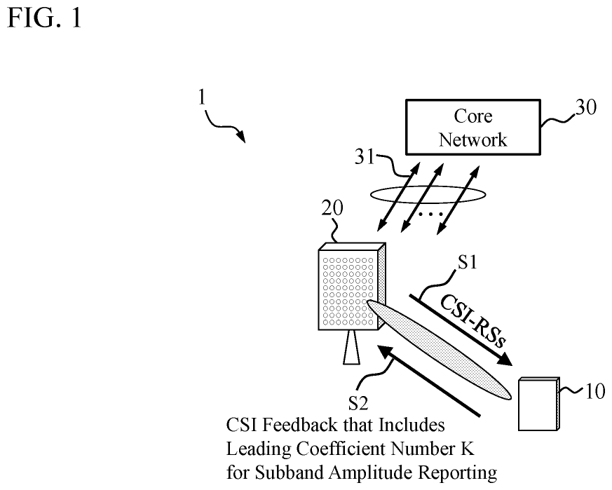

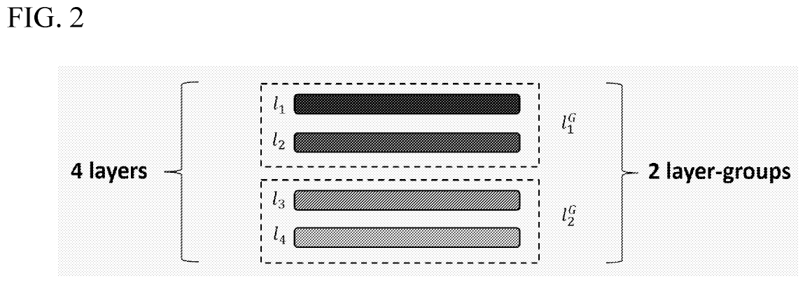

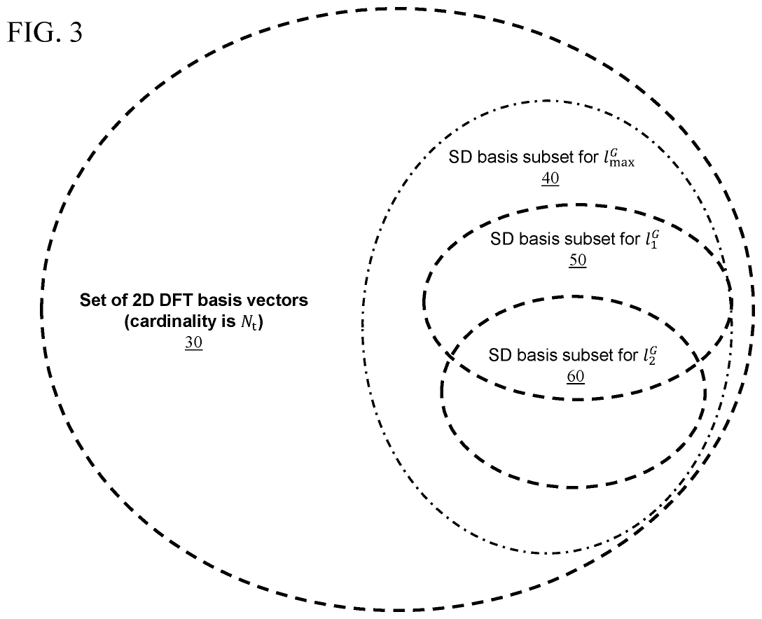

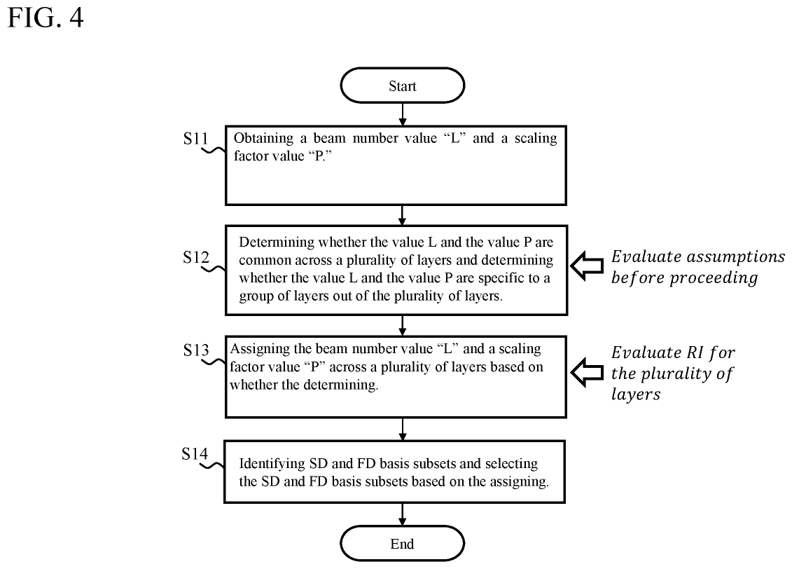

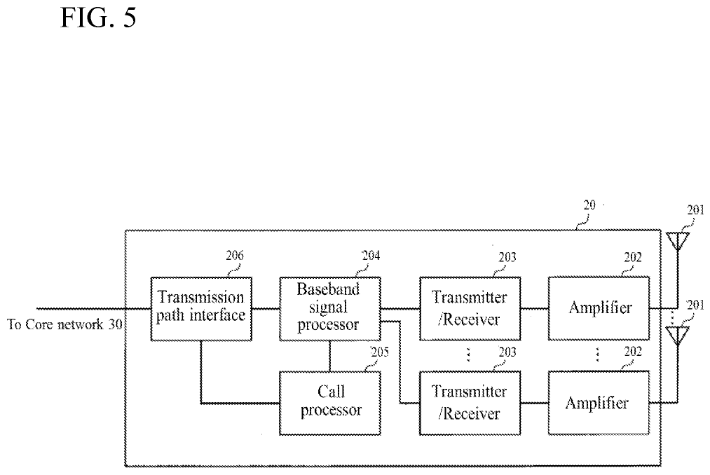

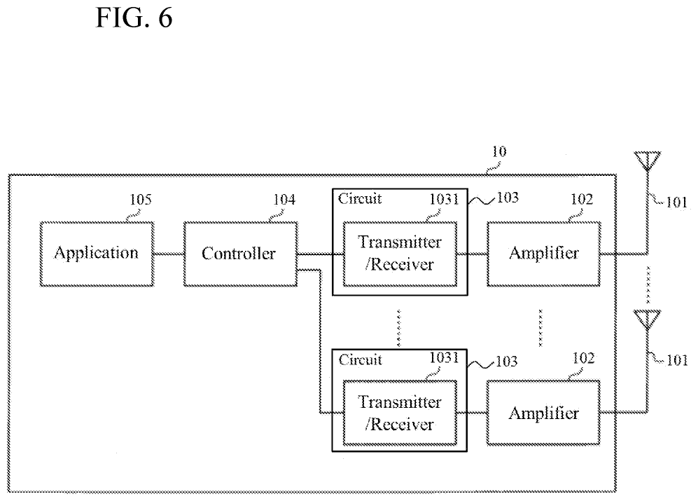

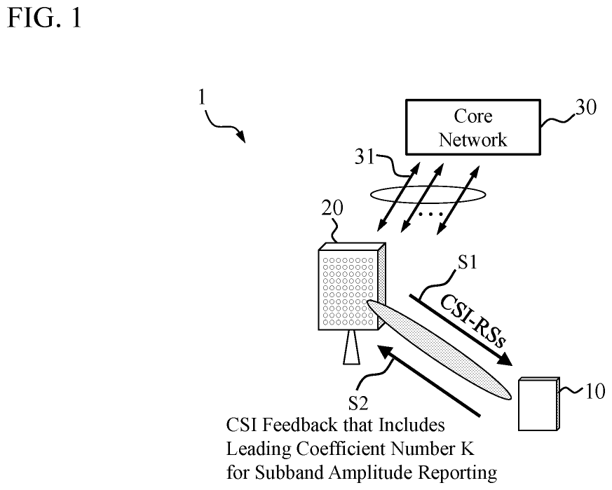

A wireless communication system 100 according to one or more embodiments of the present invention will be described below with reference to FIG. 1.

As shown in FIG. 1, the wireless communication system 100 includes a User Equipment (UE) 10, a Base Station (BS) 20, and a core network 30. The wireless communication system 100 may be an New Radio (NR) system or a Long Term Evolution (LTE)/LTE-Advanced (LTE-A) system.

The BS 20 communicates with the UE 10 via multiple antenna ports using a multiple-input and multiple-output (MIMO) technology. The BS 20 may be gNodeB (gNB) or Evolved NodeB (eNB). The BS 20 receives downlink packets from a network equipment such as upper nodes or servers connected on the core network 30 via the access gateway apparatus, and transmits the downlink packets to the UE 10 via the multiple antenna ports. The BS 20 receives uplink packets from the UE 10 and transmits the uplink packets to the network equipment via the multiple antenna ports.

The BS 20 includes antennas for MIMO to transmit radio signals between the UE 10, a communication interface to communicate with an adjacent BS 20 (for example, X2 interface), a communication interface to communicate with the core network (for example, S1 interface), and a CPU (Central Processing Unit) such as a processor or a circuit to process transmitted and received signals with the UE 10. Functions and processing of the BS 20 described below may be implemented by the processor processing or executing data and programs stored in a memory. However, the BS 20 is not limited to the hardware configuration set forth above and may include any appropriate hardware configurations. Generally, a plurality of the BSs 20 may be disposed so as to cover a broader service area of the wireless communication system 1.

The UE 10 communicates with the BS 20 using the MIMO technology. The UE 10 transmits and receives radio signals such as data signals and control signals between the BS 20 and the UE 10. The UE 10 may be a terminal, a mobile station, a smartphone, a cellular phone, a tablet, a mobile router, or information processing apparatus having a radio communication function such as a wearable device.

The UE 10 includes a CPU such as a processor, a RAM (Random Access Memory), a flash memory, and a radio communication device to transmit/receive radio signals to/from the BS 20 and the UE 10. For example, functions and processing of the UE 10 described below may be implemented by the CPU processing or executing data and programs stored in a memory. The UE 10 is not limited to the hardware configuration set forth above and may be configured with, e.g., a circuit to achieve the processing described below.

The wireless communication 1 supports Type II CSI feedback. As shown in FIG. 1, at step S1, the BS 20 transmits CSI-reference signals (RSs). When the UE 10 receives the CSI-RSs from the BS 20, the UE 10 performs measurements of the received CSI-RSs. Then, at step S2, the UE 10 performs CSI reporting to notify the BS 20 of the CSI as CSI feedback. For example, the CSI includes at least one of rank indicator (RI), precoding matrix index (PMI), channel quality information (CQI), CSI-RS resource indicator (CRI), a wideband (WB) amplitude, a subband (SB) amplitude, and a SB phase. In one or more embodiments of the present invention, the CSI reporting that reports the SB amplitude may be referred to as SB amplitude reporting. For example, rather than reporting the SB amplitude every time when the CSI reporting takes place, the periodicity of reporting the SB amplitude may be dynamically adjusted using higher layer signaling from the BS 20. The SB amplitude reporting may be performed for K leading coefficients. For example, if K is small, the number of coefficients reporting SB amplitudes is small.

If the SB amplitudes are significantly small compared to an amplitude of the strongest coefficient, achievable gains with SB amplitude reporting may be marginal. That may occur when a user channel is highly sparse in an environment with very few scatterers, for example.

Furthermore, in one or more embodiments, while Type II CSI feedback may allow layer handling up to layers with RI of 1 and 2, by altering the scheme, Type II CSI feedback may also be implemented in ranks greater than 2. As such, by extending Type II CSI feedback scheme for rank >2, spectral efficiency can be further enhanced. Extending the Type II CSI feedback scheme to ranks greater than 2 may reduce the overhead generally associated with the scheme.

To this point and as indicated above, Type II CSI precoding vector generation for N₃ precoding matrix indicator (PMI) sub-bands (SBs) considering RI=v, layer l∈{1,2, . . . v} transmission may be evaluated expanding on rule (2). For example,

Wₗ(Nₜ×N₃)=W_{1,l}W_{coeff}, (3)

In the above equation, W_{1,l}(Nₜ×2L) is a matrix consisting of L SD 2D-DFT basis for layer 1, L is a Beam number, Nₜ is a Number of ports, and W_{coeff, i} (2L×N₃) is an SB complex combination coefficient matrix for layer 1.

In the above equations, SD 2D-DFT basis subset may be given as {b_{l,1}, . . . b_{l,L}} where b_{l,i} is an i-th (∈{1, . . . , L}) 2D DFT basis vector corresponding to an l-th layer.

In one or more embodiments, frequency domain compression must be accounted for as information within W_{coeff,l} may be compressed. As such, corresponding overhead may be further reduced. For example, Type II CSI precoding vectors of layer l for N_{SB} sub-bands (SBs) considering FD compression can be given by expanding W_{coeff,l} from rule (3).

W₁(Nₜ×N_{SB})=W_{1,l}\tilde{W}ₗW_{freq,l}^{H} (4)

In the above equation, W_{freq,l} (N₃×M) is a matrix consisting of M FD DFT basis vectors for layer l and \tilde{W}ₗ(2L×M) is a matrix consisting of complex combination coefficients for layer l. Furthermore, frequency domain DFT basis subset may be given as {f_{l,1}, . . . f_{l,M}} where f_{l,i} is i-th (∈{1, . . . , M}) DFT basis vector corresponding to the l-th layer. Additionally, M is calculated as,

$$M = ⌈ p \times \frac{{N}_{3}}{R} ⌉$$

where R∈{1,2} in a way that, M depends on p and if p is known M can be determined. As such, given L and p, SD and FD basis subsets for layer 1 can be identified.

In one or more embodiments, in order to achieve a proper balance between performance and overhead, it is important to identify SD and FD bases across layers appropriately.

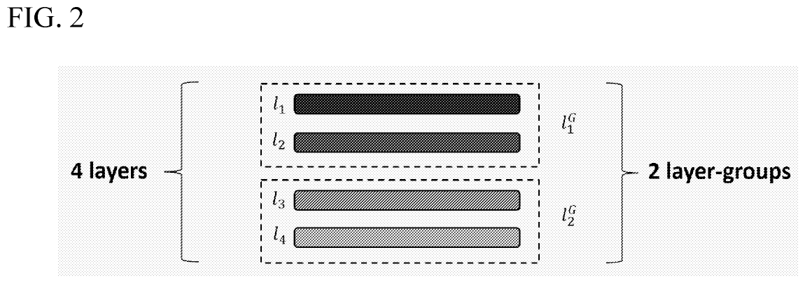

FIG. 2 is a diagram showing an example arrangement of layers and layer groups according to one or more embodiments. For example, in a case where the RI∈quals 4, and a number of layer groups equals 2, the values of the beam number and scaling factor may be implemented for all layers, a group of layers, or specific layers. As such, it is possible to assign (L, p) across layers/layer groups and to identify SD/FD basis subsets, given (L, p) across layers/layer-groups for RI∈{3,4}.

In one or more embodiments, for RI∈{3,4}, SD and FD basis selection may be achieved based on how (L, p) is identified. For example, in a case where (L, p) is common for all layers in a given rank, RI=v, lettingL=L1 and p=p1, then all the layers may select SD basis subset consisting of L1 2D DFT basis vectors and FD basis subset consisting of p1 DFT basis vectors. This may be called a common layer assigning.

In one or more embodiments, for RI∈{3,4}, SD and FD basis selection may be achieved based on how (L, p) is identified. For example, in a case where (L, p) is layer group-specific in a given rank, RI=v, grouping together available layers and letting a number of layer-groups be G(≤v), then a g^{th} layer-group, l_{g}^{G} may be assigned for (L_{g}, p_{g}), g∈{1,2, . . . G} with L_{g} 2D DFT basis vectors (SD subset) and p_{g} DFT basis Vectors (FD subset). This may be called a group-specific assigning. For example, in group-specific assigning, there is no restriction to assign layer-group-common L or ρ (for SD or FD basis subsets respectively) while the other one with layer-group-specific assignment.

As such, in one or more embodiments, for SD basis subset, L_{g}, g∈{1,2, . . . G} may be layer-group-common, L_{g1}, =L_{g2} with g₁, g₂∈{1,2, . . . G} and g₁≠g₂ while for FD basis subset p_{g}, g∈{1,2, . . . G} may be layer-group specific. Thus, assigning is not restricted to having single layer groups, (i.e., G=v either for SD or FD basis selection or for both). This may be called layer-specific assignment.

In one or more embodiments, the configurations described above may follow common layer, group-specific, and layer-specific configurations. In the case of common layer configuration, for (L, ρ), the UE 10 may assume L and/or ρ to be configured by higher layer parameters. If the UE 10 is not configured with values of L and/or ρ, the UE 10 may consider predetermined values for L and/or ρ.

Similarly, the UE 10 may assume a set of values for L and/or ρ to be configured by higher layer parameters, and the UE 10 may assume that one value for L and/or p of the set may be as indicated by x-bit(s) downlink control (DCI) or by using higher layer signaling. In such event, the UE 10 may be informed which value to use as (2-1) x is specified (e.g. x=2) and (2-2) x is flexible depending on the number of values per one set, which are configured by higher layer signaling. For example, if 4 value per set is configured, the UE 10 assumes 2 bits in DCI; if 8 values per set is configured, the UE 10 assumes 3 bits in DCI.

Furthermore, the UE 10 may assume a set of values for L and/or p is predetermined, and the UE 10 may assume that one value of the set for L and/or p as indicated by x-bit(s) DCI, where (3-1) x is specified in the specification (e.g. x=2).

In the case of group or layer-specific configuration, the UE 10 may assume {L₁, . . . L_{G}} and/or {ρ₁, . . . ρ_{G}}, to be configured by higher layer parameters. If the UE 10 is not configured with values of {L₁, . . . L_{G}} and {ρ₁, . . . ρ_{G}}, then the UE 10 may consider predetermined values for {L₁, . . . L_{G}} and {ρ₁, . . . ρ_{G}}. Similarly, the UE 10 may assume that value sets for {L₁, . . . L_{G}} and {ρ₁, . . . ρ_{G}} may be configured by higher layer parameters, and the UE 10 may assume at least one value set for {L₁, . . . L_{G}} and {ρ₁, . . . ρ_{G}} as indicated by x-bit(s) DCI or using higher layer signaling. In which case, the UE 10 may be informed which value to use given that (2-1) x is specified (e.g., x=2) and (2-2) x is flexible depending on the number of values per one set, which are configured by higher layer signaling (e.g., if 4 value sets are configured, the UE 10 assumes 2 bits in DCI; if 8 value sets are configured, the UE 10 assumes 3 bits in DCI). Furthermore, the UE 10 may assume that at least a value set for {L₁, . . . L_{G}} and {p1, . . . pc} may be predetermined. As such, the UE 10 may assume one value set out of those sets as indicated by x-bit(s) DCI (3-1) x is specified (e.g., x=2).

In one or more embodiments, basis subsets may be selected. Selecting basis subsets may also be divided into common layer, group-specific, and layer-specific configurations. As such, in a case where the configuration is common layer, to identify SD and FD basis subsets, the following options can be considered.

Opt. 1: Common SD basis and common FD basis

In this case, all layers in RI=v, a common 2D DFT SD basis subset may be selected. Therefore, {b_{l,1}, b_{l,L}} is the same for ∀l∈{1,2, . . . v}. Furthermore, for all layers in RI=v, a common FD basis subset is selected. Hence, {f_{l,1}, . . . f_{l,M}} is the same for ∀l∈{1,2, . . . v}.

Opt. 2: Common SD basis and independent FD basis.

In this case, all layers in RI=v, a common 2D DFT SD basis subset may be selected. Hence, {b_{l,1}, . . . b_{l,L}} is the same for ∀l∈{1,2, . . . v}. Furthermore, independent FD basis subsets may be selected by different layers. Hence, {fₗ_{₁}_{,1}, . . . fₗ_{₁}_{,L}}≠{fₗ_{₂}_{,1}, . . . fₗ_{₂}_{,M}} with l₁,l₂∈{1,2, . . . v} and l₁≠l₂.

Opt. 3: Independent SD basis and Common FD basis.

In this case, independent SD basis subsets may be selected by different layers. Hence, {b_{l,11}, . . . bₗ_{₁}_{,L}}≠{bₗ_{₂}_{,1}, . . . bₗ_{₂}_{,L}} with l₁,l₂∈{1,2, . . . v} and l₁≠l₂. Furthermore, for all layers L in RI=v, a common FD basis subset is selected. Hence, {f_{l,1}, . . . f_{l,M}) is the same for ∀l∈(1,2, . . . v}.

Opt. 4: Independent SD basis and independent FD basis.

In this case, independent SD basis subset may be selected by different layers. Hence, {bₗ_{₁}_{,1}, . . . bₗ_{₁}_{,L}}≠{bₗ_{₂}_{,1}, . . . bₗ_{₂}_{,L}} with l₁,l₂∈{1,2, . . . v} and l₁≠l₂. Furthermore, independent FD basis subsets may be selected by different layers. Hence, {fₗ_{₁}_{,1} . . . fₗ_{₁}_{,M}}≠{fₗ_{₂}_{,1}, . . . fₗ_{₂}_{,M}} with l₁,l₂∈{1,2, . . . v} and l₁≠l₂.

In view of the above, in one or more embodiments, some of the following advantages may be perceived in common layer configurations. Such advantages may include less feedback overhead since SD and FD basis subsets are common for all layers and better performance since SD and FD basis subsets are layer specific. Furthermore, the UE 10 may provide a better balance between feedback overhead and performance compared to other options.

Kayer and group specific configurations may perceive similar advantages. As such, to identify SD basis subset in group-specific configuration, the following options may be considered for SD basis subset selection.

Opt. 1: Independent SD basis subsets are selected by different layer-groups. In this case, {bₗ_{₁}_{^{G}}_{,1}, . . . bₗ_{₁}_{^{G}}_{,L}_{₁}}≠{bₗ_{₂}_{^{G}}_{,L}_{₁}, . . . bₗ_{₂}_{^{G}}_{,L}_{₂}} with l₁^{G}, l₂^{G}∈{1,2, . . . G} and l₁^{G}≠l₂^{G}. If L_{g}, g∈{1,2, . . . G} is a common layer-group, then different layer-groups will have different SD basis subsets with the same cardinality.

Opt. 2: For all layer-groups G (≤σ) in RI=v, 2D DFT SD basis subsets are selected from a common subset of 2D DFT beams. The cardinality of this subset is, Lₘₐₓ=max{L₁ . . . L_{G}}. For example, letting layer-group lₘₐₓ^{G} be assigned with Lₘₐₓ and the corresponding SD basis subset being [symbol] _{L}={bₗ_{ₘₐₓ}_{,1}_{^{G}}, . . . ,bₗ_{ₘₐₓ}_{,L}_{ₘₐₓ}_{^{G}}}. Then, layer-group lᵢ^{G}∈{1,2, . . . G}\lₘₐₓ^{G} will have a SD basis which is a subset of [symbol] _{L}.

The following options may be considered for FD basis subset selection.

Opt. 1: Independent FD basis subsets are selected by different layer-groups. In this case, {fₗ_{₁}_{^{G}}_{,1}, . . . f_{L}_{₁}_{^{G}}_{,M}_{₁}}≠{fₗ_{₂}_{^{G}}_{,1}, . . . fₗ_{₂}_{^{G}}_{,M}_{₂}} with l₁^{G}, l₂^{G}∈{1,2, . . . G} and l₁^{G}≠l₂^{G}. If M_{g}, g∈{1,2, . . . G} is a common layer-group, then different layer-groups will have different FD basis subsets with the same cardinality.

Opt. 2: For all layer-groups G (≤σ) in RI=v, DFT FD basis subsets are selected from a common subset of DFT beams. The cardinality of this subset is, Mₘₐₓ=max{M₁ . . . M_{G}}. For example, letting layer-group lₘₐₓ^{G} being assigned with Mₘₐₓ and the corresponding FD basis subset is [symbol] _{M}={fₗ_{ₘₐₓ}_{^{G}}_{,L}_{₁}, . . . fₗ_{ₘₐₓ}_{^{G}}_{,L}_{ₘₐₓ}}. Then, layer-group lᵢ^{G}∈{1,2, . . . G}\lₘₐₓ^{G} will have a FD basis which is a subset of [symbol] _{M}. Subsequently, if M_{g}, g∈{1,2, . . . G} is layer-group-common, [symbol] _{M} is the same for all layer-groups.

Advantageously, the above configurations provide better performance since SD and FD basis subsets are layer-group specific. Additionally, less feedback overhead is required since SD and/or FD basis subsets are selected from a smaller subset of the original set.

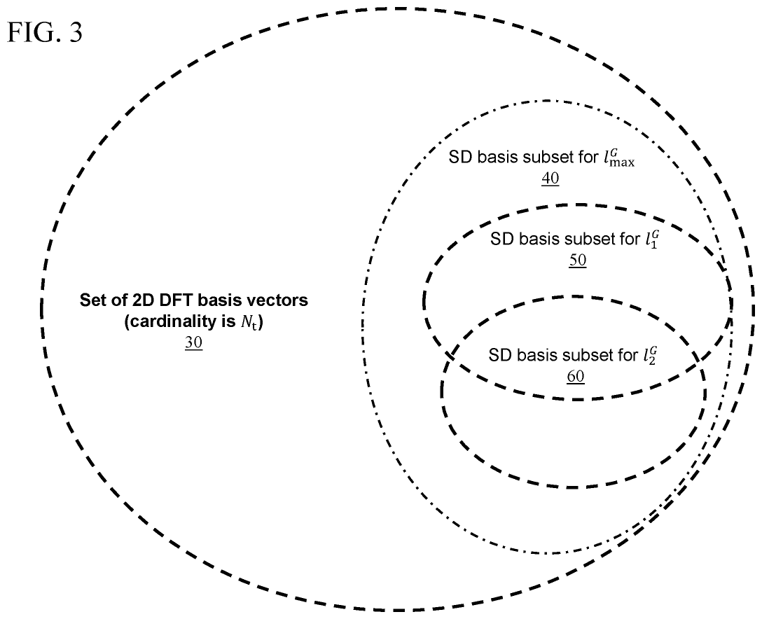

FIG. 3 is an example according to one or more embodiments. For example, FIG. 3 shows set representation of possible SD basis subsets for layer-groups. As mentioned above, if L_{G} is layer-group-common, with rule (4), the same SD basis subset will be assigned for all layer-groups.

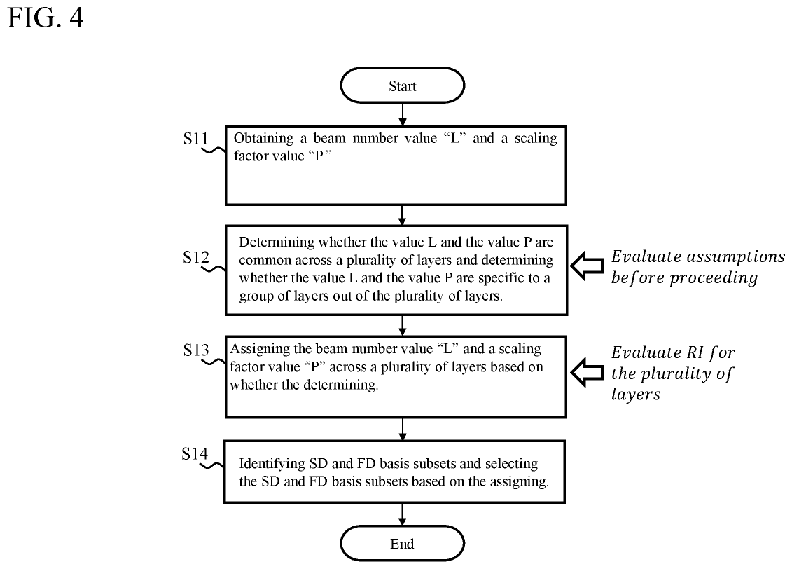

FIG. 4 is a flowchart diagram showing an operation in the wireless communication system 1 according to one or more embodiments.

As shown in FIG. 4, at step S11, the UE 10 may obtain values for beam number “L” and scaling factor “ρ.” In sequence or alternatively, in step S12, the UE 10 may determine the configuration for the identified layers. Mainly, the UE10 may evaluate the plurality of assumptions described above and determine a layer configuration that satisfies the values of “L” and “ρ.” In sequence or alternatively, in step S13, the UE10 may implement the selected configuration in such a way that Type II CSI Feedback may be applied to ranks greater than 2. In sequence or alternatively, in step S14, SD and FD basis subsets may be identified based on assigned values of “L” and “P.”

In one or more embodiments, while identifying the basis subsets, the UE may assume a method for selecting SD and/or FD basis subsets based on a predetermined rule. Similarly, while identifying the basis subsets, the UE may derive which SD and FD basis subset selection option to consider out of the 4 options discussed above under common 13 layer (L, p) for basis subset selection. Additionally, such consideration may include using DCI or higher layer signaling. In particular, this may be achieved as indicated by x-bit(s) DCI or using higher layer signaling, where (2−1) x is specified (e.g., x=2).

At this point, if the configuration is layer-specific, then the UE may assume that selecting SD and/or FD basis subsets is predetermined. Similarly, the UE may derive the selecting of SD and/or FD basis subsets using DCI or higher layer signaling. Based on different possibilities available on how to select SD and/or FD basis subsets, x1-bit(s) and x2-bit(s) may be allocated respectively for DCI or using higher layer signaling, UE can understand which option to use given that (2-1) x1 and x2 are specified (e.g., x₁=1 and x₂₌₁).

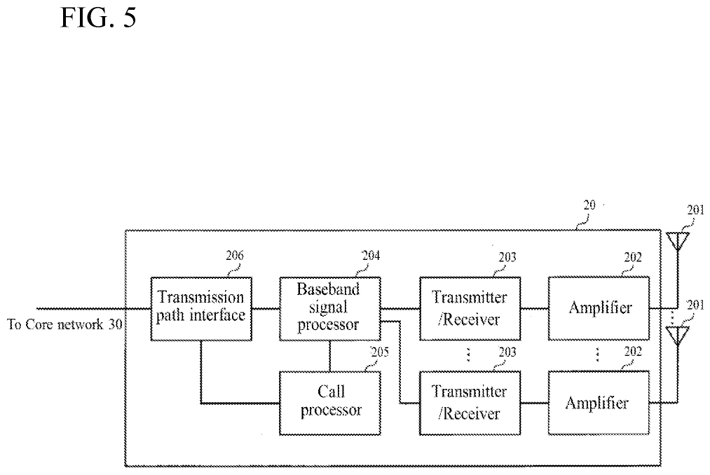

The BS 20 according to one or more embodiments of the present invention will be described below with reference to the FIG. 5.

As shown in FIG. 5, the BS 20 may comprise an antenna 201 for 3D MIMO, an amplifier 202, a transmitter/receiver circuit 203 (hereinafter referred as including a CSI-RS scheduler), a baseband signal processor 204 (hereinafter referred as including a CS-RS generator), a call processor 205, and a transmission path interface 206. The transmitter/receiver 202 includes a transmitter and a receiver.

The antenna 201 may comprise a multi-dimensional antenna that includes multiple antenna elements such as a 2D antenna (planar antenna) or a 3D antenna such as antennas arranged in a cylindrical shape or antennas arranged in a cube. The antenna 201 includes antenna ports having one or more antenna elements. The beam transmitted from each of the antenna ports is controlled to perform 3D MIMO communication with the UE 10.

The antenna 201 allows the number of antenna elements to be easily increased compared with linear array antenna. MIMO transmission using a large number of antenna elements is expected to further improve system performance. For example, with the 3D beamforming, high beamforming gain is also expected according to an increase in the number of antennas. Furthermore, MIMO transmission is also advantageous in terms of interference reduction, for example, by null point control of beams, and effects such as interference rejection among users in multi-user MIMO can be expected.

The amplifier 202 generates input signals to the antenna 201 and performs reception processing of output signals from the antenna 201.

The transmitter included in the transmitter/receiver circuit 203 transmits data signals (for example, reference signals and precoded data signals) via the antenna 201 to the UE 10. The transmitter transmits CSI-RS resource information that indicates a state of the determined CSI-RS resources (for example, subframe configuration ID and mapping information) to the UE 20 via higher layer signaling or lower layer signaling. The transmitter transmits the CSI-RS allocated to the determined CSI-RS resources to the UE 10.

The receiver included in the transmitter/receiver circuit 203 receives data signals (for example, reference signals and the CSI feedback information) via the antenna 201 from the UE 10.

The CSI-RS scheduler 203 determines CSI-RS resources allocated to the CSI-RS. For example, the CSI-RS scheduler 203 determines a CSI-RS subframe that includes the CSI-RS in subframes. The CSI-RS scheduler 203 determines at least an RE that is mapped to the CSI-RS.

The CSI-RS generator 204 generates CSI-RS for estimating the downlink channel states. The CSI-RS generator 204 may generate reference signals defined by the LTE standard, dedicated reference signal (DRS) and Cell-specific Reference Signal (CRS), synchronized signals such as Primary synchronization signal (PSS) and Secondary synchronization signal (SSS), and newly defined signals in addition to CSI-RS

The call processor 205 determines a precoder applied to the downlink data signals and the downlink reference signals. The precoder is called a precoding vector or more generally a precoding matrix. The call processor 205 determines the precoding vector (precoding matrix) of the downlink based on the CSI indicating the estimated downlink channel states and the decoded CSI feedback information inputted.

The transmission path interface 206 multiplexes CSI-RS on REs based on the determined CSI-RS resources by the CSI-RS scheduler 203.

The transmitted reference signals may be Cell-specific or UE-specific. For example, the reference signals may be multiplexed on the signal such as PDSCH, and the reference signal may be precoded. Here, by notifying a transmission rank of reference signals to the UE 10, estimation for the channel states may be realized at the suitable rank according to the channel states.

The BS 20 further, in one or more embodiments, comprising hardware configured for reducing feedback overhead associated with bitmap reporting between a user equipment and a base station. For example, the BS 20 may include the capabilities described above for reducing feedback overhead when communicating with the UE 10.

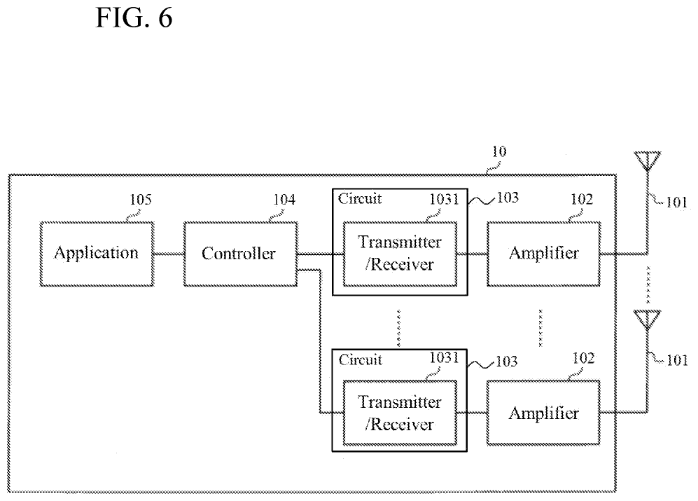

The UE 10 according to one or more embodiments of the present invention will be described below with reference to the FIG. 6.

As shown in FIG. 6, the UE 10 may comprise a UE antenna 101 used for communicating with the BS 20, an amplifier 102, a transmitter/receiver circuit 103, a controller 104, the controller including a CSI feedback controller and a codeword generator, and a CSI-RS controller. The transmitter/receiver circuit 103 includes a transmitter and a receiver 1031.

The transmitter included in the transmitter/receiver circuit 103 transmits data signals (for example, reference signals and the CSI feedback information) via the UE antenna 101 to the BS 20.

The receiver included in the transmitter/receiver circuit 103 receives data signals (for example, reference signals such as CSI-RS) via the UE antenna 11 from the BS 20.

The amplifier 102 separates a PDCCH signal from a signal received from the BS 20.

The controller 104 estimates downlink channel states based on the CSI-RS transmitted from the BS 20, and then outputs a CSI feedback controller.

The CSI feedback controller generates the CSI feedback information based on the estimated downlink channel states using the reference signals for estimating downlink channel states. The CSI feedback controller outputs the generated CSI feedback information to the transmitter, and then the transmitter transmits the CSI feedback information to the BS 20. The CSI feedback information may include at least one of Rank Indicator (RI), PMI, CQI, BI and the like.

The CSI-RS controller determines whether the specific user equipment is the user equipment itself based on the CSI-RS resource information when CSI-RS is transmitted from the BS 20. When the CSI-RS controller 16 determines that the specific user equipment is the user equipment itself, the transmitter that CSI feedback based on the CSI-RS to the BS 20.

The UE 10 further, in one or more embodiments, comprising hardware configured for reducing feedback overhead associated with bitmap reporting between a user equipment and a base station. For example, the UE 10 may include the capabilities described above for reducing feedback overhead when communicating with the BS 20.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of Channel State Information (CSI) feedback in a wireless communication system, the method comprising:
obtaining, with a user equipment, a first value that is a beam number value;
obtaining, with the user equipment, a second value that is a scaling factor value for a vector pattern of a size M; and
assigning, with the user equipment, the first value and the second value across a plurality of layers,
wherein the plurality of layers are layers with a rank indicator (RI) of a value being greater than 2.

2. The method according to claim 1, further comprising:
assigning, with the user equipment, the first value and the second value to layers in a given rank out of the plurality of layers,
wherein the first value and the second value are common for the layers in the given rank.

3. The method according to claim 1, further comprising:
assigning, with the user equipment, the first value and the second value to a specific group of layers out of the plurality of layers in a given rank,
wherein the first value and the second value are specific to the specific group of layers in the given rank, and
wherein a size of the specific group of layers is variable.

4. The method according to claim 3, wherein the first value and the second value are assigned to a specific layer when the size of the specific group of layers equals l.

5. The method according to claim 2, further comprising:
obtaining the first value and the second value, with the user equipment, by assuming predetermined values for the first value or the second value to be configured by higher layer parameters.

6. The method according to claim 2, further comprising:
obtaining, with the user equipment, a set of values for the first value and a set of value for the second value, by:
assuming values for the set of values for the first value or the set of values for the second value to be configured by higher layer parameters; and
assuming that at least one value out of the set of values for the first value or at least one value out of the set of values for the second value as indicated by downlink control information (DCI) or using higher layer signaling.

7. The method according to claim 2, further comprising:
obtaining, with the user equipment, a set of values for the first value and a set of value for the second value, by:
assuming predetermined values for the set of values for the first value or the set of values for the second value; and
assuming that at least one value out of the set of values for the first value or at least one value out of the set of values for the second value as indicated by DCI.

8. The method according to claim 3, further comprising:
obtaining, with the user equipment, the first value and the second value by assuming values for the first value or the second value to be configured by higher layer parameters.

9. The method according to claim 3, further comprising:
obtaining, with the user equipment, a set of values for the first value and a set of values for the second value by:
assuming values for the set of values for the first value or the set of values for the second value to be configured by higher layer parameters; and
assuming that at least one value out of the set of values for the first value or at least one value out of the set of values for the second value as indicated by DCI or using higher layer signaling.

10. The method according to claim 3, further comprising:
obtaining, with the user equipment, a set of values for the first value and a set of values for the second value by:
assuming predetermined values for the set of values for the first value or the set of values for the second value; and
assuming that at least one value out of the set of values for the first value or at least one value out of the set of values for the second values indicated by DCI.

11. A method of identifying Space Domain (SD) and Frequency Domain (FD) basis subsets in a wireless communication system, the method comprising:
obtaining, with a user equipment, a first value that is a beam number value;
obtaining, with the user equipment, a second value that is a scaling factor value for a vector pattern of a size M;
determining, with the user equipment, whether the first value and the second value are common across a plurality of layers;
identifying the SD and FD basis subsets based on assumption that:
the plurality of layers comprises a first common SD basis and a first common FD basis;
the plurality of layers comprises a second common SD basis and a first independent FD basis;
the plurality of layers comprises a first independent SD basis and a second common FD basis; or
the plurality of layers comprises a second independent SD basis and a second independent FD basis; and
selecting the SD and FD basis subsets based on the assumption.

12. The method according to claim 11, wherein when the plurality of layers comprises a first common SD basis and a first common FD basis:
a common 2D Discrete Fourier Transform (DFT) SD basis subset is selected for layers of a same rank indicator (RI); and
a common FD basis subset is selected for the layers of the same rank index.

13. The method according to claim 11, wherein when the plurality of layers comprises a second common SD basis and a first independent FD basis:
a common 2D DFT SD basis subset is selected for layers of a same RI; and
a plurality of ED basis subsets is selected by different layers among of the plurality of layers.

14. The method according to claim 11, wherein when the plurality of layers comprises a first independent SD basis and a second common FD basis:
a plurality of SD basis subsets is selected by different layers among of the plurality of layers; and
a common FD basis subset is selected for the layers of the same RI.

15. The method according to claim 11, wherein when the plurality of layers comprises a second independent SD basis and a second independent FD basis:
a plurality of SD basis subsets is selected by different layers among of the plurality of layers; and
a plurality of FD basis subsets is selected by different layers among of the plurality of layers.

16. A method of identifying Space Domain (SD) and Frequency Domain (FD) basis subsets in a wireless communication system, the method comprising:
obtaining, with a user equipment, a first value that is a beam number value;
obtaining, with the user equipment, a second value that is a scaling factor value for a vector pattern of a size M;
determining, with the user equipment, whether the first value and the second value are specific to a group of layers out of a plurality of layers;
identifying the SD and FD basis subsets; and
selecting the SD and FD basis subsets based on the identified SD and FD basis subsets.

17. The method according to claim 16, wherein when selecting SD basis subsets, the user equipment determines whether independent SD basis subsets are selected by different layer groups within the plurality of layers or Discrete Fourier Transform (DFT) SD basis subsets are selected from a common subset of DFT beams.

18. The method according to claim 16, wherein when selecting FD basis subsets, the user equipment considers whether independent FD basis subsets are selected by different layer groups within the plurality of layers or 2D Discrete DFT SD basis subsets are selected from a common subset of 20 DFT beams for all layer groups within the plurality of layers.

19. A user equipment performing channel state information (CSI) feedback in a wireless communication system, the user equipment comprising:
a receiver that receives a CSI-reference signal (RS) from a base station;
a transmitter that transmits CSI feedback to the base station based on the CSI-RS;
a processor that:
obtains a first value that is a beam number value;
obtains a second value that is a scaling factor value for a vector pattern of a size M;
determines whether the first value and the second value are common across a plurality of layers;
determines whether the first value and the second value are specific to a group of layers out of the plurality of layers;
identifies the SD and FD basis subsets; and
selects the SD and FD basis subsets.

20. The user equipment of claim 19, wherein when the processor determines that the first value and the second value are common across the plurality of layers, the processor selects the SD and FD basis subsets by:
assuming a predetermined rule for selecting; or
assuming a configuration out of four different possible configurations using Downlink Control Information (DCI) or higher layer signaling.

21. The user equipment of claim 19, wherein the processor determines whether the first value and the second value are specific to the group of layers out of the plurality of layers, the processor selects the SD and ED basis subsets by:
assuming a predetermined rule for selecting; or
assuming a configuration out of four different possible configurations using DCI or higher layer signaling.
